(19) United States
(12) Patent Application Publication
(10) Pub. No.: US 2006/0226109 A1
(43) Pub. Date: Oct. 12, 2006

(54) Integrated food package for infants

(76) Inventors: Peter Ellegaard, Poway, CA (US); Ken Sung, San Diego, CA (US); Paul DeKleermaeker, La Jolla, CA (US)

Correspondence Address: Joseph Page, PO Box 757, La Jolla, CA, 92038, US

(21) Appl. No.: 11/102,504

(22) Filed: Apr. 8, 2005

(51) Int. Cl. A61J 9/00

(52) U.S. Cl. 215/11.3; 215/11.4

(57) ABSTRACT

An infant feeding apparatus is formed of a filled reservoir, sealed and coupled to a nipple by way of a special coupling element. Gentle tactile manipulation breaks a seal and creates a flow path such that the contents of the reservoir are permitted to pass through the nipple tip. As the package is made of discardable materials it is expendable after use. These packages are designed as one-time use, disposable packages. They are prepared with integrated food; ready for consumption. In best versions, a highly unique cap and nipple design enables a plurality of functions desirable in packages of this nature. These systems include: a cap which drives various function related to flow control; a specialized nipple element; a base element provides a coupling to both the reservoir envelope containing food and to the cap which maintains a sanitized seal but is removable and replaceable under simple tactile manipulation.

### BACKGROUND OF THE INVENTIONS

1. Field

The following inventions disclosure is generally concerned with packaging for food product and specifically concerned with highly functional complete packages for baby formula foods.

2. Prior Art

The art is well tended by a considerably large group of inventors each presenting useful and interesting variations of baby bottles, each of these having particular features and function. The state of the art may be gleaned from the more recent of these inventions which include:

Inventor Villanueva teaches a bottle with food in a two part dry and liquid state which are to be mixed together just before consumption in U.S. Pat. No. 6,669,013. This system requires a two compartment bag with a seam therebetween which can be broken allowing the components to mix. Thereafter, the mixed food is dispensable through a single flow path nipple. The apparatus does not provide for special seals at the exterior which permit one to maintain high levels of cleanliness. In addition, the package requires some pre-operational steps (i.e. mixing) before use. While Villanueva offers a convenient package with food incorporated therein, special care must be taken to enjoy safe use of these kinds of systems.

U.S. Pat. No. 6,666,345 teaches a cap for use with a water bottle or in combination with a baby bottle. This cap has special fastening features which make it an important improvement in the field. However, it does not operate to maintain a sanitized environment about its dispensing tip and does not include many of the desirable functions useful with baby bottles such as flow control and tight temporary resealing.

Inventor Anderson presents an interesting sealing mechanism which protects a liquid until such time as it is desired to be dispensed. U.S. Pat. No. 6,644,471 describes the seal and puncture mechanism which permits initiation of flow from a previously sealed package. While this system offers exceptional protection for contained liquids, it would be quite difficult or impossible to arrange it in conjunction with a nipple which is necessary in baby bottle type apparatus.

A disposable and recyclable beverage device is subject of U.S. Pat. No. 6,612,428. Like that described as Villanueva's invention, the inner bag of this invention comprises two compartments and a mixing operation is carried out prior to dispensing. Sometimes, it is not desirable to maintain food in a state where mixing is required before use as found in these systems.

An invention having a vacuum flow rate control is described as U.S. Pat. No. 6,578,740. Flow control is an important feature for advanced baby bottles, however the flow controls of the '740 invention do not support the objectives typically found in baby bottles.

A re-closable baby bottle liner and bottle are disclosed in U.S. Pat. No. 6,576,278 issued Jun. 10, 2003. A mechanical interlock provides a seal which may be opened and re-closed between uses.

Each of the following similarly teach of one related aspect or another: Witherspoon, U.S. Pat. No. 6,302,286; Bougamont et al, U.S. Pat. No. 6,334,556; Guillot, U.S. Pat. No. 5,785,213; Gross et al, U.S. Pat. No. 6,273,307; and Dunn et al, U.S. Pat. No. 5,544,766.

While systems and inventions of the art are designed to achieve particular goals and objectives, some of those being no less than remarkable, these inventions have limitations which prevent uses in new ways now possible. Inventions of the art are not used and cannot be used to realize the advantages and objectives of the inventions taught herefollowing.

### SUMMARY OF THE INVENTIONS

Comes now, Peter Ellegaard, Ken Sung, and Paul DeKleermaeker with inventions of food packaging including devices specifically configured for the special needs associated with baby feeding. It is a primary function of these systems to provide safe, effective and complete packaging for baby foods and feeding. It is a contrast to prior art methods and devices that those systems do not provide for the functionality taught herefollowing; particularly with respect to the integrated nature of a total package. A fundamental difference between food packages of these inventions and those of the art can be found when considering its ready-to-use nature. Integrated systems form a complete package, the package being pre-filled and suitable for long term storage in a ‘ready-to-use’ state. The package includes built-in seals and flow control mechanisms which are easily operated by simple tactile pressure without compromising sanitation of contents. A parent can serve a baby's meal simply by applying a gentle tactile force and serving.

Packages of these inventions, are most generally described as a sealed containment reservoir having prepared food therein. Further, this sealed reservoir is coupled to a dispensing article such as a nipple via a unique coupling element. The coupling element is characterized by its two interfaces; a first which operates to form a sealed joint with a vessel body thus forming a complete containment vessel, and a second which operates to couple a complex material such as silicon rubber or ‘latex’ to a the system.

In best versions, the containment vessel is primarily comprised of laminate material to form a flexible, durable bag which easily collapses as its contents are passed therefrom. The materials may be formed from plastics or metal foils or combinations of plastics and metal foils. When combined with the coupling element, a stable, air-tight containment vessel is formed and is suitable for storage of food products therein, in particular liquefied baby foods.

Charged and sealed reservoir units are stable for storage and transport until desired time-of-use. These reservoir units are opened at the time of service via a tactile operation which opens a reservoir seal and couples its contents to the exit port of a dispensing article such as a latex nipple.

In advanced versions, adjustable flow control means are provided. A user operates a flow control means by tactile adjustment of apparatus components to effect adjustments to the liquid flow paths. Still further, some advanced versions of these systems provide for discrete steps which correspond to pre-set flow rate values which are easy to select via mechanical indexing of the system parts.

### OBJECTIVES OF THESE INVENTIONS

It is a primary object of these inventions to provide improved baby feeding packaging and systems.

It is an object of these inventions to provide a self-contained complete package of ready-to-use baby formula meals.

A better understanding can be had with reference to detailed description of preferred embodiments and with reference to appended drawings. Embodiments presented as examples are particular ways to realize these inventions and are not inclusive of all ways possible. Therefore, there may exist embodiments that do not deviate from the spirit and scope of this disclosure as set forth by the claims, but do not appear here as specific examples. It will be appreciated that a great plurality of alternative versions are possible.

### BRIEF DESCRIPTION OF THE DRAWING FIGURES

These and other features, aspects, and advantages of these inventions will become better understood with regard to the following description, appended claims and drawings where:

FIG. 1 an exploded view diagram of three primary components from which devices are formed;

FIG. 2 is a similar exploded view illustration a two part coupling element;

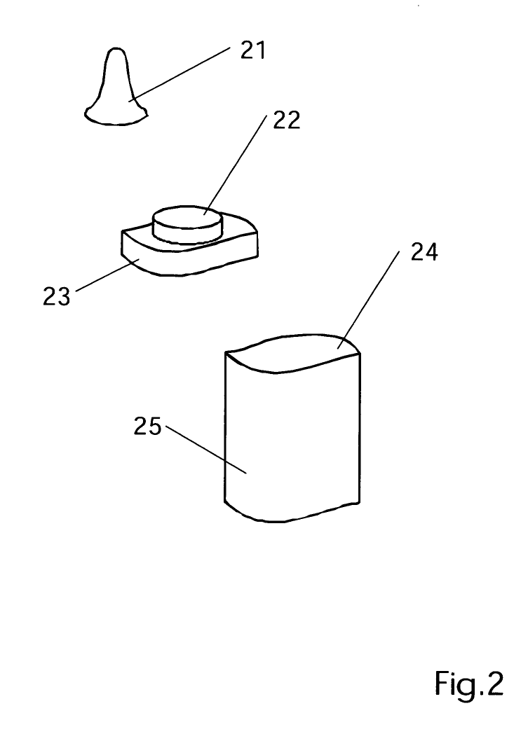

FIG. 3 illustrates a first simple version;

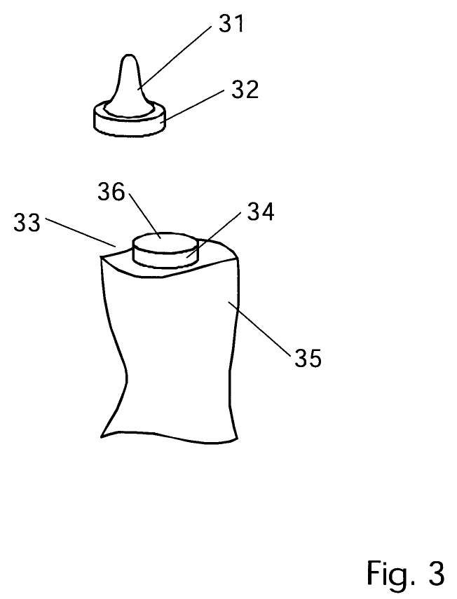

FIG. 4 is perspective expanded view of a preferred best mode example of these inventions;

FIG. 5 is block diagram of major elements from which these apparatus may be formed;

FIG. 6 is more detailed block diagram including some minority elements and systems sub-elements;

FIG. 7 illustrates a cap member of preferred versions;

FIG. 8 is a cross sectional view to illustrate the spatial relationship between cooperating elements;

FIG. 9 illustrates a version with a conventional rigid bottle added thereto;

FIG. 10 illustrates one of several possible versions of flow control; and

FIG. 11 illustrates an alternative flow control mechanism.

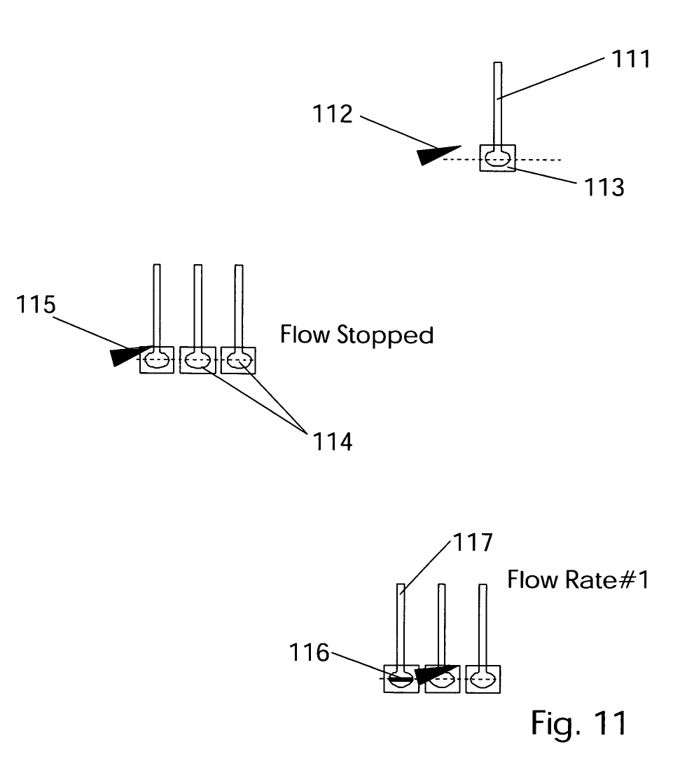

### PREFERRED EMBODIMENTS OF THESE INVENTIONS

In accordance with each of the preferred embodiments of these inventions, baby bottle apparatus are provided. It will be appreciated that each of the embodiments described includes an apparatus and that the apparatus of a first preferred embodiment may be different than the apparatus of another embodiment.

For health and safety, it is of critical importance to maintain a highly aseptic state in baby feeding systems such as baby bottles and their associated parts. Great care must be taken to avoid contaminating the baby bottle while it is being stored, transported or prepared for use. One solution to address this need, includes complete ready-to-use packages which do not require preparation; or which require only minimal preparation That preparation being taken in a manner which allows the system to remain free from germs and contaminants.

A baby bottle can be prepared with a ready-for-consumption liquid food in a sealed and sanitized container. In this way, the food contents is protected from bacteria and other contaminants up to the moment of use. Food is prepared and packaged under safe conditions at a manufactures' facility and while it is stored in the sealed package, there is no opportunity for it to become spoiled by contaminants. Just before use, the package seal is opened to permit the contents to leave the container. These packages require no cooking, heating, mixing, stirring or other preparation.

To implement such systems in a baby's bottle configuration, a highly novel ergonomic interface, or ‘nipple’ is required. In addition, a specially configured food containment envelope appropriate for the application is necessary. Both the containment envelope and the nipple interface with a unique coupling element. In addition, some versions include a specially designed cap which integrates with the coupling element and the nipple such that it can be manipulated without exposing system parts to contaminants.

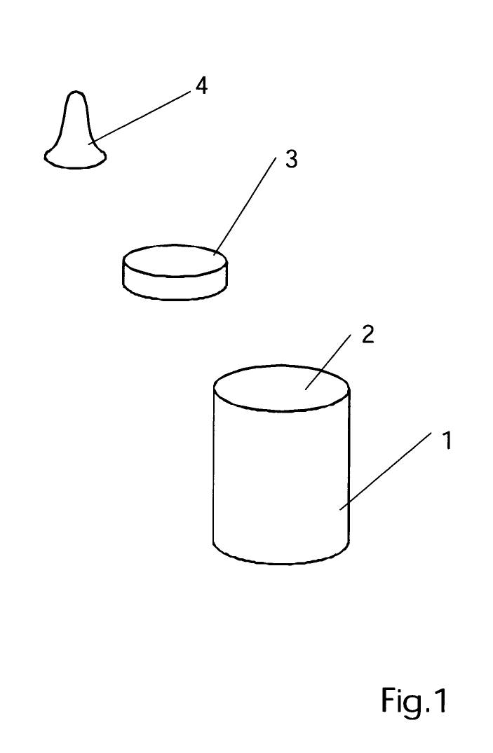

With reference to FIG. 1, primary elements are set forth in simple line drawings. A reservoir 1 operates to contain liquids therein. The reservoir is an envelop of flexible durable material which collapsible upon about itself as its contents are removed. The envelop may be formed of plastics or polymers, metals such as foils, or laminate materials of both plastics and metals. The reservoir top 2 is open such that it may be bonded with another system element to form a complete enclosure. A coupling element 3, is fashioned such that it can be sealed to the reservoir at its top. In addition, the coupling element provides a fluid tight interface for the nipple 4. When a nipple is properly joined with the coupling element, and the coupling element affixed to the reservoir, liquid in the reservoir can only leave its containment via the port at the nipple tip.

Coupling elements of these inventions may take many forms. It is for this reason that it is drawn in symbolic form in the reference figure. One will appreciate that several mechanical implementations might exist which achieve the primary function first taught here. Thus, these inventions are more appropriately defined by the claims appended hereto rather than the more specific examples following. It will be appreciated, that no other system of the arts currently suggests using a sealed flexible bag in the manner described herein. This is partly due to the difficulty of interfacing a nipple with such materials in a long term stable package. The coupling element is made to be a cooperating interface with the nipple and reservoir.

In a first illustrative example, a nipple 21 is affixed to a first portion 22 of a coupling element. A second portion of a coupling element 23 is designed to receive and form a bond with the top peripheral edge 24 of reservoir 25 formed of a flexible laminate material such as plastic laminated foil. The coupling element is fashioned whereby it forms a seal with the silicon rubber from which preferred nipples are comprised. In addition, the coupling element is suitable for bonding with the thin materials from which the envelope reservoir is formed.

A coupling element might be in two parts which couple together via mechanical means such as a complementary thread set on each of the two parts. This is important for best versions where the flow of liquid contents is controlled. It is desirable that the reservoir completely contain liquids therein without permitting flow into and through the nipple until the time for desired consumption. Thus a temporary seal at the coupling element can be implemented to serve this function. A nipple 31 is securely affixed to first portion of coupling element 32. The nipple and coupling element first portion may be held separated from the reservoir assembly 33. The second portion of the coupling element 34 is bonded and affixed, for example via adhesives, to the flexible envelope 35. A foil seal 36 at the top of the second portion of the coupling element keeps liquids contained in the reservoir. The underside of the first portion of the coupling element might be arranged with a cutting tool such that when the portions of the coupling elements are brought together via their threads, the tool cuts the foil permitting liquid to flow to the nipple interior. In the way, the package is secure and stable until the time of intended use. As the top is merely screwed onto the container, i.e. the coupling element parts are screwed together, flow is initiated. After contents are consumed, the entire device may be discarded in accordance with appropriate recycling protocol.

While the presented description suggests the true spirit and nature of the whole invention, that is, a disposable system having a flexible bag coupled to a nipple via a coupling element whereby pre-charged liquid baby foods prepared by the manufacture are stable and safely stored until time of use, when a top is manipulated and flow is initiated, the preceding sections are directed to most general cases and therefore simple line drawings are used. However, in the spirit of teaching the very best modes known to these inventors, the following sections present a detailed example of one implementation which is particularly attractive. It should not detract from the true scope of their inventions that they suggest this specific example in this way.

Best mode versions of these inventions include a flexible reservoir joined with a silicon rubber nipple via a coupling element. In addition, these versions also include a cap element which mechanically operates special indexed flow control means by way of the nipple. Further, the cap provides a temporary reseal function. These caps may be operated by way of tactile pressure. By way of mechanical interoperability, the cap and its subsystems interact with both the coupling element and the nipple element. The nipple element forms an operational relationship with both the cap and the coupling element. The coupling element, or sometimes referred to as a ‘base element’, touches each of the other major elements: the cap, the nipple, and the reservoir in an functional way and there is a highly unique relationship between each.

Accordingly, these integrated baby feeding packages comprise as major elements a cap, a nipple, a base, and a reservoir. In addition to these major elements, these systems also are said to include additional cooperative elements such as food, a rigid bottle, griping means, flow control, and tamper resistance mechanisms, among others. One gains a more thorough understanding in view of the following description with references to the drawing figures.

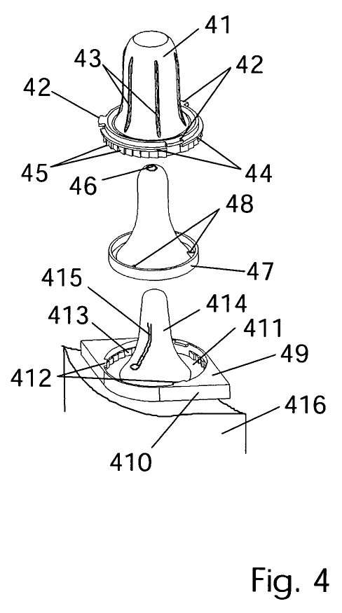

FIG. 4 illustrates an example package in an exploded perspective view. A cap element 41 includes on its outer surfaces an attachment ring with tab stops 42, gripping ribs 43, and mechanical guide ridges 44. In addition, saw tooth indexing teeth 45 form the bottom peripheral edge and mating surfaces of the cap. The cap also includes an indexing slot at its underside (not shown in this figure) which engages a corresponding tab on the nipple when they are aligned and in proximity. An ergonomic interface or ‘nipple’, may be formed of a thin latex rubber or silicon rubber material which is useful for a feeding interface as it is preferred by babies. At its tip, a nipple may have an exit port 46 from which fluid is permitted to pass. The nipple at its bottom may include a retaining means 47 and aligning tabs 48. The retaining means and aligning tabs function to hold the nipple assembly to the base and further to couple the nipple to the cap so that it rotates with the cap when the cap is in place thereon the nipple. The nipple may further include at its underside (not shown in the drawing) a feature which interacts with the base to initiate and sometimes prevent flow from the fluid reservoir. A base element may include a diamond shaped platform 49, having flat sides 410 operable for bonding laminate materials thereto, a recess 411 into which lie tab stops 412, complementary saw tooth indexing teeth 413. A base post 414 extends from the base platform upwardly with a predetermined shape specially designed to cooperate with the nipple. The post includes flow control mechanism which may be embodied in various configurations including at least a port and channel 415 which provides a fluid flow path towards the opening in the nipple. Finally a containment vessel or reservoir 416 may be formed of a flexible envelope of material appropriate for containing liquids in a sanitized state. The envelope may be filled with baby food formula and permanently affixed to the base at its flat sides by ultrasonic welding or other adhesives suitable for forming a strong and secure bond between these materials.

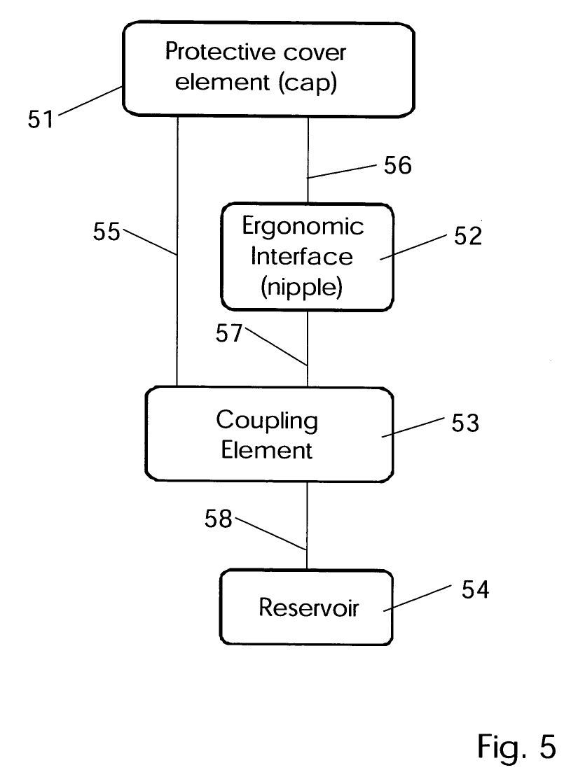

A concise block diagram of FIG. 5 illustrates major system elements and relationships therebetween. In particular, a protective cover element or ‘cap’ 51, an ergonomic interface (or more simply ‘nipple’) 52, a base element 53, and a reservoir 54. The cap covers and protects the nipple from contaminants. The cap which mechanically interlocks 55 with receiving ridges and saw tooth structures on the base also couples 56 with the nipple such that it turns with the cap so long as the cap is in proximity to the nipple and is rotated about its axis. The nipple lies on 57 the base post and the base post imparts shape and support thereto the nipple. The base is affixed 58 to the reservoir via a joint formed between them for example welding or adhesive joints.

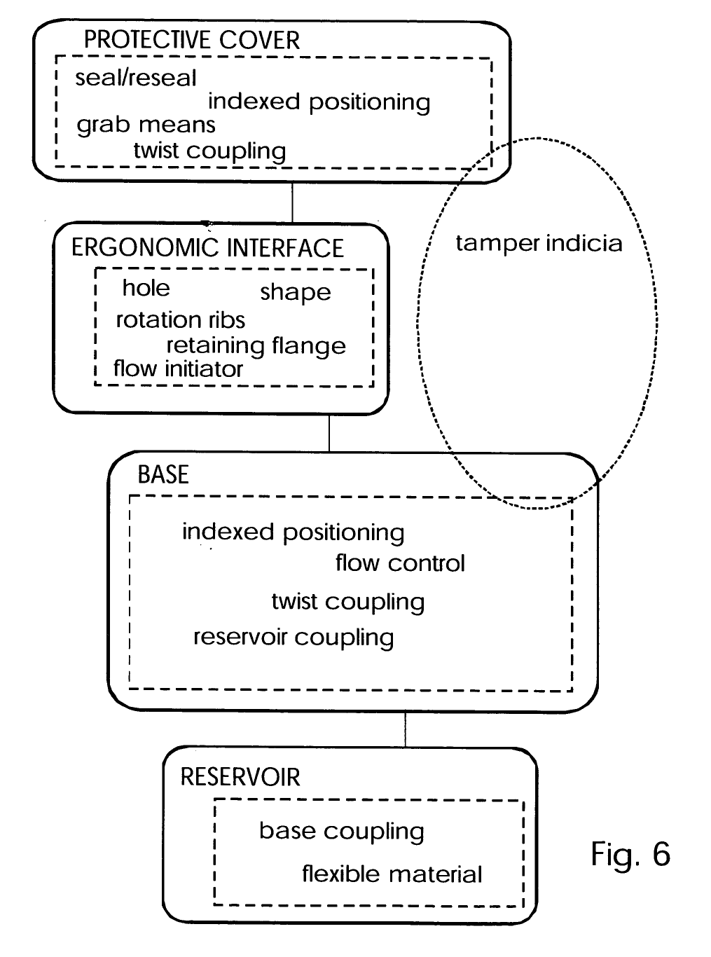

A better understanding of subsystems and their association with each of the major parts is presented in view of the diagram of FIG. 6 which suggests the subsystems in relation with their hosting elements. The cap includes mechanisms to form a seal between the cap and base. In addition, the cap has an indexing system which defines a plurality of discrete positions in relation with the base. A grip means is included on the outside surface of the cap such that twisting the cap through indexed positions is made more easy. A twist coupling which permits the cap to be twisted from the base includes an attachment ring with tab stops.

The ergonomic interface, herein used synonymously with ‘nipple’, is distinct in its shape which is designed in accordance with those shapes preferred by babies and infants. The nipple includes a hole or port at its tip. At its lower periphery, the nipple includes a retaining flange with alignment or rotation tabs. In the cavity at the concave inside portion nipple, the nipple may include a device(s) for initiating flow control.

A base element of these devices includes subsystems defined as follows: an index positioning means which cooperates with the cap locking teeth to promote preset positions of the cap/nipple combination with respect to the base. The base includes flow control related systems built into an exterior surface of a conic shaped portion of the base. A twist coupling of the base joins with the cap and includes a receiving ridge and stop tabs. The base also includes a specially shaped lower peripheral ridge which couples to the top edge of an envelope reservoir.

A reservoir has a top edge suitable for forming a bond with the rigid material of the base lower edge. The reservoir is comprised of a flexible material appropriate for containing liquids and protecting them in a sanitized state.

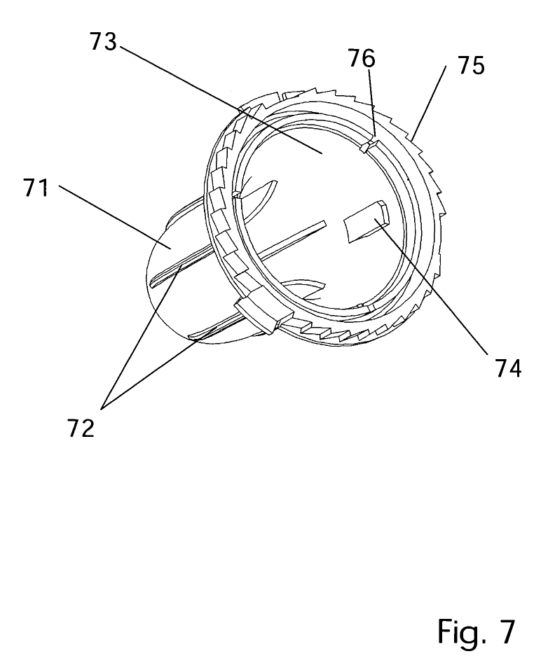

A detailed drawing of the inside surface of a cap element 72 is presented as FIG. 7. The exterior surface includes raised ridges 72 for easy turning. The interior surface 73 in some specific versions includes cam 74 which operates to push on the outside surface of the nipple, and still further to the base post. When turning the cap, the cam is arranged to cause a valve to open or a foil seal to become torn and punctured. The cam transmits a pushing force through the nipple wall and to the base. Various mechanical systems can be arranged, each having its benefits, where the twisting of the cap promotes the opening of a flow path. It is impossible to attempt to catalogue them here. It will be sufficient to say, that a cap, driven under tactile twisting forces, opens a flow path.

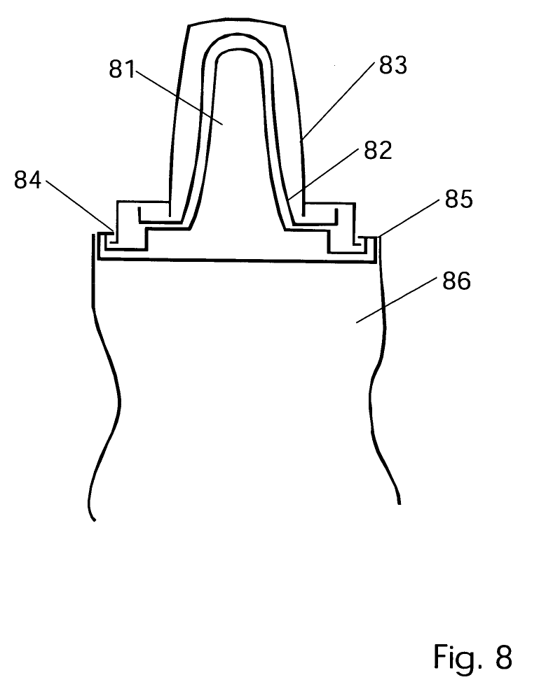

FIG. 8 illustrates how elements fit into and relate with the others. A base element 81 includes a partly rigid upwardly extending conic portion which forms the support for a thin soft nipple 82 element thereon. Onto the base, the nipple lies in close fitting contact over the rigid conic member. At the lowermost retaining ring, the nipple can be formed slightly smaller that the base post whereby when pushed together, they form a seal which liquid does not easily pass. Over the base/nipple combination, the cap 83 forms a seal at its lower edge 84 with the base member at the receiving ridge. The base is joined at bond 85 to the flexible reservoir envelope 86.

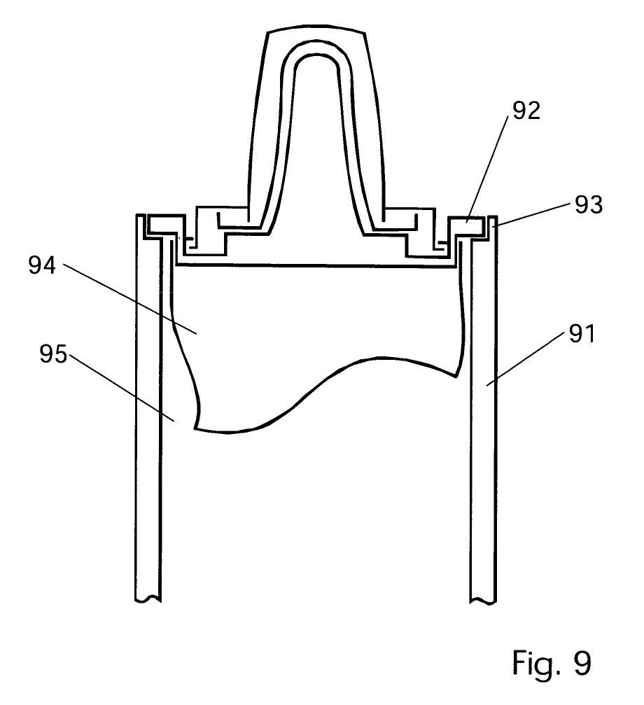

In some versions, the base additionally includes means to couple the entire system to a rigid baby bottle body. FIG. 9 shows a rigid baby bottle body 91 coupled to the base via a special ridge 92 at a complementary lip 93 of the rigid bottle. The flexible reservoir 94 is contained within the bottle body and in the usual fashion, the bag is allowed to shrink leaving air to fill the space 95.

While basic elements are introduced above, further details presented herefollowing will make certain the configurations and arrangements of best modes anticipated.

Protective Cover Element—Cap

A first important element of preferred versions of these inventions is the specialized cap. While it is common to seal baby bottles with a cap, those caps do not share the properties of caps presented here. Caps of these inventions are designed with a primary purpose to protect and maintain the sanitized state of these feeding packages and their components. The cap additionally has the function of providing access and operability to flow controlling means via tactile motions. Additionally, caps of these inventions provide a resealing function. Finally, in some versions these caps are arranged to cooperate with other elements to provide a tamper indication system.

The cap couples to both the base and at the same time to the nipple. The cap is received at a recess in the base at a ridge designed to couple with an attachment ring of the cap. The cap is coupled in manner whereby a rim portion at the cap bottom forms a mechanical interlock with the base but permits the cap to be twisted about an axis. The rim portion, although formed integrally with the cap includes a break-away mechanism such that when appropriate force is applied the cap rim separates from the cap body, the rim staying coupled to the base while the cap is freed and removable from the system. The break-away mechanism may be formed as a perforated plastic ridge between the cap and the cap rim portion.

In addition, the cap couples to the nipple via rotation ribs distributed in several places on the interior of a retaining flange. The cap having corresponding receiving slots at its undersurface, engages the ribs causing the nipple to be rotationally linked with the cap. When the cap is rotated about its axis, it causes the nipple to rotate also. Thus the cap and nipple rotate together about the base which is held fixed.

At the bottom edge or rim of the cap around its periphery are indexing teeth. These teeth mesh with cooperating inward facing teeth in the recess of the base element. When the cap is twisted with respect to base, these teeth pass each other to permit rotation in a single direction only. With advancement, the teeth pass each other to provide a ‘click’ which may be easily felt by the user. The ‘click’ which occurs each time a set of teeth pass each other, i.e. teeth of the cap and teeth of the base, corresponds to another predetermined position. In some preferred versions, the cap and base form four set positions. A first position corresponds to a sealed condition where flow is blocked. Each of three successive positions corresponds to an increased flow rate. Users can ‘feel’ these positions via the clicks felt when operating the cap.

While the perforation between the cap and the cap rim is durable enough that the cap may be twisted in the first direction without fracturing, attempts to twist the cap in the opposing direction cause the perforation to fracture and cap to separate from its coupling to the base via the cap rim.

Opposing teeth offer a most certain ‘click’, however, nearly identical manner and purpose is achieved via a detent and opposing bump system to provide an indexing means. When turning a cap properly prepared in accordance with this version, the user feels natural stops in the various relative positions with respect to the cap and base. These natural stops are aligned such that each corresponds to different flow rate. This will become better understood in view of the description following directed to the nipple.

Since the cap engages the base member and nipple via friction and interlock fit and in a manner which results in the cap needing a significant level of twisting pressure to adjust and/or remove, the cap preferably incorporates a large diameter at the region where a user grips with the hands. The large diameter permits a users hand to deliver more torque to the cap to encourage it to twist. In addition, raised ridges may be put on the exterior surface of the cap to further improve the grip and increase tactile feel and efficiency.

While a twisting relationship is preferred, slight mechanical variations provides logical alternatives. For example, a push-pull relationship between a cap and base also could be arranged to serve the same purpose and function. A mechanical interlock may be formed such that the cap is pushed past a rib on the base extending the entire circumference. The inventive advantage is not found in the precise nature of any mechanical implementation but rather the overall cooperation and relationships between major parts. When a cap includes a re-sealable function with respect to the base while simultaneously manipulates the nipple to control flow, then the limits of the invention are found.

A primary function of the cap includes forming a seal to protect the cleanliness of sensitive parts of the package. During manufacture, certain elements of the package are sanitized. These include the ergonomic interface, and portions of the base. The cap forms a tight seal at its seat where it joins the base. The integrity of the seal is such that it cannot easily be penetrated by bacterium or other harmful matter. When a cap is purposefully removed from the base, for example by a mechanical twisting action between the base and the cap, the seal is broken and the ergonomic interface—nipple is exposed for use. The cap and base combination is purposefully designed whereby it may be easily removed such that it is not necessary to touch the nipple in the removal process. In this way, the nipple remains contamination free.

Some container tops of the arts operate in modes whereby they are removed and immediately discarded. In the present inventions, it is preferred that tops are formed with special care so that when they are reapplied to the base, they again form a strong and secure seal with high integrity. Although small amounts of bacteria from prior use may reside on the nipple, further contamination is prevented from other perhaps more harmful sources. Thus, caps of preferred versions of these packages include those which may be resealed when reapplied to the base. To achieve this function, the mating surfaces of both the base and the cap are prepared with precision and design with a view to that function. On the inside of the cap, a ridge of small diameter may be pushed passed a corresponding similar ridge at the base or nipple to form an temporary interlock which holds the cap securely to the base, albeit with less security than the perforation which is stronger and more durable but not resealable.

In review, the cap is twisted in a first direction with respect to the base to set a preferred position and corresponding flow rate, and then twisted in a reverse direction to cause a break-away action and permit its removal. These steps to break a primary seal (break-away perforation) therebetween the cap and base, and to break a secondary seal between the nipple and the base, and further to drive a flow control mechanism That is, further twisting is used to align the nipple element with respect to the base element in any of several discrete positions associated with a predefined flow rate.

Ergonomic Interface—Nipple

The ergonomic interface of these inventions, the nipple, is not precisely the same as those commonly used in baby bottles. Indeed, its shape and size is at least similar to those available in the art. However, several features of the nipple cannot be found deployed in known systems. These include, among others: a reduced thickness, cooperation with a base member, an integrated flow control mechanism, a retaining ridge, and flow coupling means.

Of primary importance is the cooperation with the base. The base includes an elongated portion of specific shape. This tip portion of the base is designed with particular shape and texture. While the nipple fits tightly over the base tip, the base tip imparts its shape and feel to the nipple. The tip may be arranged as a highly porous flexible plastic member, similar to a synthetic sponge. When a nipple of these inventions is tightly covering the tip, the combination yields a special feel not found in nipples of the art. The base tip is more rigid than a simple silicon rubber nipple of common baby bottles and promotes a more natural feel. Also, the nipple supported by the base prevents collapse of the nipple which might interrupt or otherwise disturb proper flow.

The nipple is secured to the base via its retaining flange. At the bottom periphery of the nipple element there is a rigid retaining flange arranged to couple the nipple to the base whereby it may rotate about the base on their common axis. The retaining flange provides means to couple with the interior portion of the cap. Rotation ribs are aligned and sized such that they are engaged by slots in the underside of the cap. When the cap is atop the nipple in close proximity, rotations of the cap force the nipple to rotate on the base tip.

The interior surface of the nipple is also very special in its construction. The interior of the nipple may include a mechanical means to control flow rate. In various versions, the underside surface includes implements which operate in conjunction with corresponding implements on the base to permit liquid flow. Thus users can adjust the flow in accordance with demand required for different conditions.

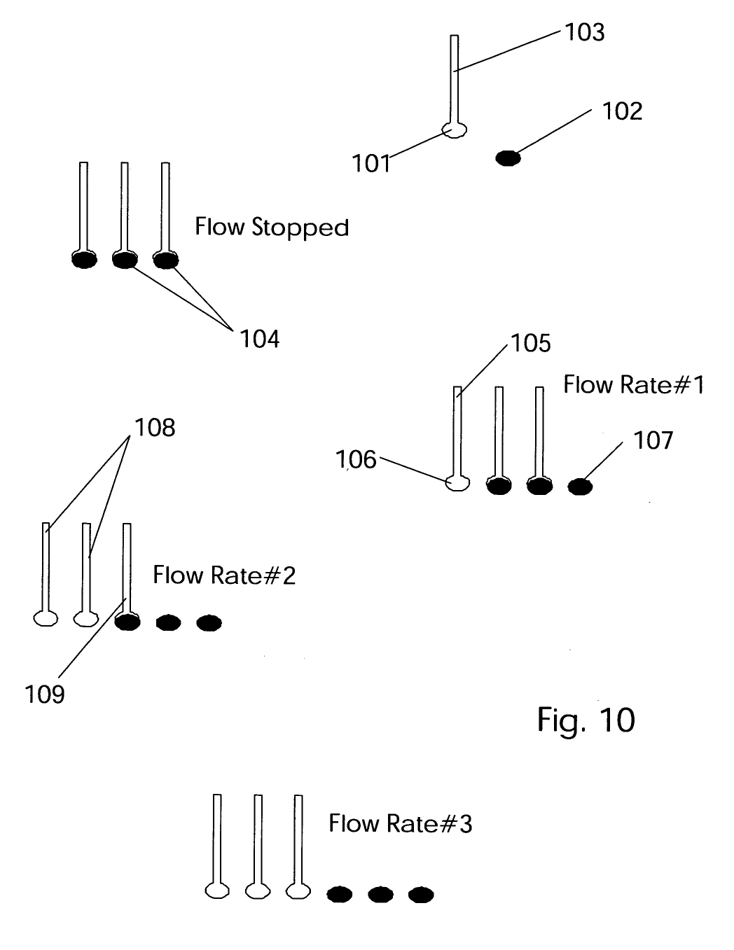

In a first version, a base post has an opening of a specific size and shape while the interior surface of the nipple wall has a cooperating raised ‘bump’ or plug of complementary size and shape, which could be as small as one millimeter in thickness, which fits into the opening thus blocking it. When the plug on the nipple is displaced from the opening in the base, for example when the nipple is twisted from its original location, the unblocked opening operates to permit flow of liquid from the reservoir. In preferred versions, a plurality of holes and bumps could operate in conjunction to permit 4 discrete flow rates. This is more clear in view of FIG. 10 which illustrates the cooperation between holes and plugs. The holes being part of the base post and the plugs being part of the nipple. In the figure, a hole 101 in the base post forms a path for liquid flow from the interior portion of the base post and thus the reservoir to the exterior surface of the base post. Plug 102 is a small surface relief bump formed on the interior surface of the nipple. A vertical groove 103 may also be arranged on the exterior surface of the base post to create a channel to promote directional flow towards the nipple tip and exit port therein. The channel is only in the surface and does not extend into the base post interior. Thus only fluid which passes first through a hole is coupled to the channel. In a first position, three bumps fill three holes 104 and no fluid is permitted to flow. When a cap is twisted, it rotates the nipple with respect to the base and moves the bumps. Flow rate #1 is achieved when the bump set is displaced as shown in the diagram. In this position, one of the bumps 107 no longer covers any hole, and hole 106 is left open whereby liquid in the reservoir is coupled to the channel and further to the nipple port. Flow rate #2 is achieved when two bumps are moved and two holes are uncovered to allow flow through both channels 108. Channel 109 remains inactive because one bump remains blocking one hole. Finally, flow rate #3 is achieved in a fourth position where all bumps are displaced from all holes.

In an alternative scheme, a sharp edge, or lance, pierces a foil seal as the nipple is rotated past the opening blocked by the foil. The pierced foil then permits flow. FIG. 7 illustrates. Channel 111 and hole are formed in the base post and piercing lance 112 is integrated with the interior surface of the nipple. Foil 113 covers and seals the hole which couples the exterior surface with the interior of the base. In an initial state, the flow is stopped. Channels 113 carry no fluid, holes 114 are each covered by foil seals and lance 115 is in a ready position aligned to follow a path indicated by the dotted line. Twisting the cap while engaged with the rotation ribs of the nipple element causes it to turn on the system axis and rotate with respect to the base forcing the lance to pass the foil whereby it becomes pierced. Flow rate #1 is initiated after the lance passes the first hole causing a tear in the foil 116. Liquid is thereafter coupled through the channel 117. Additional flow rates #2 and #3 are addressed via further advancement of the cap and consequently the nipple to which it is connected. While highly economical and functional, these types of seals are not re-sealable as the lance cannot mend the foil in a reverse pass over the foil. Thus the first version may have some advantage as it forms a sometimes convenient seal after an initial use; i.e. the plugs may be reseated into the openings again blocking flow.

Base Element

The base element, described extensively in previously presented portions of this disclosure and is further defined here. The base is comprised of several subsystems. Namely, the base has a peripheral rim, a foundation, recess to receive the cap, a post and a tip portion. In addition, some versions also include means, preferably threaded, to couple with a rigid baby bottle. The foundation is indicated in FIG. 4 as item 49; the peripheral rim, 410, the recess, 411; and the base post, 414. The base can be formed of plastic material in a molding process. At the periphery where the envelope is to be bonded, the material must be suitable to support the bond with the sheet material from which the reservoir envelope is comprised. In addition, the base tip may be formed of special material. The base tip may be formed of a cooperating softer plastic being fused with the other parts (base post). Special processes can be applied to the tip to give it special texture and resilient properties desirable in most comfortable versions. The base post and base tip are formed carefully in conjunction with the cooperating nipple such that they are intimately related supporting the functions described herein.

Reservoir

The reservoir is a containment vessel for liquid baby food products. It is highly desirable to maintain the foods in a sanitized state up to the time of use. Thus, a reservoir is preferably a durable package made of flexible material which protects against contamination. Plastics and metallic foils may be used together to form laminates appropriate for long term storage of baby foods. The flexible package permits it to collapse during consumption whereby a vacuum can be avoided in the reservoir.

An enclosed reservoir is formed when a base element is bonded with the envelope portion. This seal may be made at the base periphery via a weld or adhesive bond for example. The base post is hollow and allows liquid contained in the envelope to pass to exit holes in the post and further to the nipple port.

In best versions, the envelope bottom is left open during assembly and manufacture. As a last step, the package is charged with the food product; i.e. the envelope is filled and a permanent seal at the package bottom finalizes the package to result in a fully ready-to-use system.

Additional Important Elements

While the text presented to here is directed to the primary inventive features, a few additional elements are mentioned herefollowing in view of some changes which might be made to those otherwise conventional parts so that they cooperate better with the elements from which these apparatus are comprised.

A first important element which should be configured with a special view to the teachings presented is the rigid bottle body. A baby cannot be expected to hold the flexible reservoir which contains the liquid food, but rather prefers to hold a rigid bottle. The bottle may be formed of hard plastics materials which are durable and safe. The reservoir containing liquid food is placed into an interior cavity of the bottle where it is protected and out of reach of the baby. Also, the flexible envelope from which the reservoir is made can shrink as food is removed preventing a vacuum which tends to disrupt flow. The bottle as described preferably couples to an outside edge of the base. Since the base is also coupled to the envelope, the base must also account for a joint mechanism with the bottle. Details of one configuration can be appreciated in view of the diagram of FIG. 9 which shows a base flange which couples to a baby bottle at its top while still permitting a joint to be made between the flex envelope and the base at its receiving surface. Finally, as these packages are designed as disposable systems, one should note that the outer bottle body may be suitable for reuse. Because of this, a coupling between the base and a bottle body element should provide for a fastener which can be released and reapplied to other fully charged units. A threaded coupling works well for this function.

The food is another important item of these inventions. While some systems are suitable with many kinds of liquid baby foods, these systems require special preparation with regard to the food product. The liquid food necessarily is integrated with the package and as such it must be stable and have a long shelf life. The food must be placed in the envelope and sealed therein in a sanitized environment. Because of these conditions imposed by the package design, the consumer has no opportunity to adjust and manipulate the food in any way. Conversely, this feature is a great benefit as one always can depend on the freshness and quality of the food as assured by the manufacturer.

While tamper indicator systems have been deployed on both baby bottles and other food packages, those tamper evident systems are unlike those suggested here. This is due to the fact that the unique cap, nipple and base taught here interact with each other in ways not found in other configurations. As such, tamper resistant systems including markings and other indicia may be uniquely applied to the cap, nipple and base in a manner to provide signals to user of prior use or tampering.

The examples above are directed to specific embodiments which illustrate preferred versions of devices of these inventions. In the interests of completeness, a most general description of devices and the elements of which they are comprised is presented herefollowing.

These inventions are characterized as food packages including a reservoir, an nipple, a coupling therebetween. Such reservoirs are flexible envelopes of durable material which contain liquid for storage. Nipples are soft rubber material. Couplings are formed of plastic materials bonded to the reservoirs and sealed with nipples. Couplings also include a seal which can be penetrated; the seal keeps liquid in the reservoir until time of desired consumption. An integrated seal breaking device breaks the seal to enable flow. A sharp knife edge can be used to tear a foil seal.

A more detailed characterization includes: a food package having a cap, a nipple, a base, a flow control and a reservoir. The cap or protective cover includes mechanical interlock to join with the base, an indexing system, and a nipple turning system. The nipple has an exit port, a turning relationship with the cap, and a retaining flange. A coupling element base has a recess, a foundation, a post and a tip. A flow control includes two element which cooperate to seal and unseal a flow path. Finally a reservoir is a collapsible envelope with a top edge fused the base.

One will now fully appreciate how a highly integrated, high function baby bottle may be arranged to preserve a highly sanitized state, ease of use and convenience. Although the present invention has been described in considerable detail with clear and concise language and with reference to certain preferred versions thereof including the best mode anticipated by the inventor, other versions are possible. Therefore, the spirit and scope of the invention should not be limited by the description of the preferred versions contained therein, but rather by the claims appended hereto.

What is claimed is:

1) Food packages comprising in combination: a reservoir; and a coupling element; said reservoir comprising a flexible envelope of durable material operable for containing liquid for storage therein, and said coupling element comprising an integrated ergonomic interface formed of plastic and bonded with said reservoir to form a breakable airtight seal that prevents liquid contained in the reservoir from passing the seal until the seal is compromised to form a flow path from the reservoir to an exterior of the food package.

2) Food packages of claim 1, said ergonomic interface is formed as a foam nipple integrated with the coupling element.

3) Food packages of claim 1, said seal is formed by a removable cap or cover element which encapsulates the ergonomic interface.

4) Food packages of claim 3, said seal is opened by penetration of a seal membrane.

5) Food packages of claim 1, said seal is formed by a membrane between said coupling element and flexible reservoir and operates via penetration of the membrane with a puncture device.

6) Food packages of claim 1, further includes a protective cover which cooperates with said coupling element whereby the ergonomic interface is maintained in a sanitized state.

7) Food packages of claim 6, said protective cover includes tamper indicia to indicate prior removal of said protective cover.

8) Food packages of claim 1, further comprising a rigid body which encloses said reservoir to provide a sturdy bottle-like apparatus.

9) Food packages comprising in combination:
a reservoir;
an ergonomic interface; and
a coupling element,
said reservoir comprising a flexible envelope of durable material operable for containing liquid for storage therein, said ergonomic interface having a tip substantially in the shape of a nipple, and said coupling element is bonded to said reservoir to form a penetrable airtight seal and is further coupled to said nipple to form a flow path from the interior of the reservoir to a port at the coupling element tip.

10) Food packages of claim 9, further comprising a removable protective cover arranged to protect said ergonomic interface and to maintain in a sanitized state.

11) Food packages of claim 10, said protective cover is a cap operable for restoring a seal to stop flow.

12) Food packages of claim 9, further comprising integrated flow control to enable an adjustable flow rate.

13) Food packages of claim 9, said ergonomic interface is a soft pliable rubber material, said coupling element joins said ergonomic interface and said reservoir to form an enclosure.

14) Food packages of claim 9, said ergonomic interface comprising a foam material having a tip substantially in the shape of a nipple.

15) Food packages of claim 9, further comprises a bond between said coupling element and reservoir characterized as a weld.

16) Food packages of claim 9, said seal is a penetrable membrane between said coupling element and said reservoir.

17) Food packages of claim 9, said seal is a penetrable membrane between said coupling element and said ergonomic interface.

18) Food packages of claim 17, said seal is opened via a twisting action of a cap covering said ergonomic interface.

19) Food packages of claim 17, said seal is opened by tactile pressure applied to the wall of said coupling element.

20) Food packages of claim 16, said seal is opened via a twisting action of a cap covering said ergonomic interface.

22) Food packages of claim 16, said seal is opened by tactile pressure applied to the wall of said coupling element.

23) Food packages of claim 9, further comprising a rigid body which encloses said reservoir to provide a sturdy bottle-like apparatus.
